(19) United States
(12) Patent Application Publication
(10) Pub. No.: US 2022/0383225 A1
(43) Pub. Date: Dec. 1, 2022

(54) Organizational Benchmarks

(71) Applicant: ADP, Inc., Roseland, NJ (US)

(72) Inventors: Jack Berkowitz, Mendham, NJ (US); Amin Venjara, Livingston, NJ (US); Zafrir Babin, Glen Rock, NJ (US); Brent Weiss, Princeton, NJ (US); Justo Pastor, Fairfield, NJ (US); Malvika Tiwari, Montclair, NJ (US); Cory Schamble, Hackettstown, NJ (US); Hafeez Raji, Huntington Station, NY (US); Mathew Skaria, East Hanover, NJ (US); Sreenath Kodedala, Budd Lake, NJ (US); Szabi Nagy, Gladstone, NJ (US); Anuj Singh, Wayne, NJ (US); Kishore Bangali, Mt. Arlington, NJ (US); Rajan Patel, Avenel, NJ (US); Siva Bangaru, Hyderabad (IN); Manoj Oleti, Hyderabad (IN); Nakul Kapoor, New Providence, NJ (US); Zeeshan Anwar, Monroe, NJ (US); Mark Anthony Maraj, Jersey City, NJ (US); Vibhor Shukla, Livingston, NJ (US); Michael Ratcliff, West Caldwell, NJ (US); Leon Liu, Livingston, NJ (US); Anil Dhotre, Parsippany, NJ (US); Annette Allen, Linden, NJ (US); WaiWah Pak, Livingston, NJ (US); Pallavi Renati, Hyderabad (IN); Praveen Kumar Kommineni, Hyderabad (IN)

(21) Appl. No.: 17/446,640

(22) Filed: Sep. 1, 2021

(30) Foreign Application Priority Data
May 28, 2021 (IN) 202141023943

(51) Int. Cl. G06Q 10/06; G06Q 10/10; G06Q 30/02; G06Q 40/00; G06F 3/0482

(52) U.S. Cl. CPC G06Q 10/06393; G06Q 10/105; G06Q 30/0201; G06Q 40/125; G06F 3/0482

(57) ABSTRACT

A method, apparatus, system, and computer program code for digitally presenting a comparison of labor resource allocations between organizations. A computer system identifies employee data for a set of employees. The employee data includes job titles, and job descriptions. Using a set of machine learning models, the computer system extracts skills data from the job descriptions. Based on the skills data extracted from the job descriptions and using the set of machine learning models, the computer system maps the job titles to normalized titles within a job taxonomy that governs relationships between business functions, subfunctions, and the normalized titles. The computer system determines a resource allocation for an organization over each of the normalized titles. The computer system generates a granular comparison of the granular resource allocation to a set of benchmark allocations. The computer system digitally presents the granular comparison in a graphical user interface.

This application claims the benefit of India Patent Application No. 202141023943, filed May 28, 2021, which is incorporated by reference herein in its entirety.

### BACKGROUND INFORMATION

### 1. Field

The present disclosure relates generally to an improved computer system and, in particular, to a method and apparatus for accessing information in a computer system. Still more particularly, the present disclosure relates to a method, a system, and a computer program product for determining and presenting a potentially competitive resource allocation for an organization.

### 2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance plans, wellness plans, and other programs and organizations using an employee information system. As another example, an information system may be used to hire new employees, assign employees to projects, perform reviews for employees, and other suitable operations for the organization. As yet another example, a research department in the organization may use an information system to store and analyze information to research new products, analyze products, or for other suitable operations.

Currently used information systems include databases. These databases store information about the organization. For example, these databases store information about employees, products, research, product analysis, business plans, and other information about the organization.

Information about the employees may be searched and viewed to perform various operations within an organization. However, this type of information in currently used databases may be cumbersome and difficult to access relevant information in a timely manner that may be useful to performing an operation for the organization. For example, understanding how much capital goes into employee compensation and where that capital is being invested may be desirable for operations such as identifying new hires, selecting teams for projects, and other operations in the organization. However, because specific responsibilities and descriptions of job positions may vary among different organizations, optimal investment strategies across a business sector often cannot be determined. Therefore, relevant information is often excluded from the analysis and performance of the operation. Furthermore, identifying appropriate investments into business units for companies of a particular size and industry may take more time than desired in an information system.

Therefore, it would be desirable to have a method and apparatus that take into account at least some of the issues discussed above, as well as other possible issues. For example, it would be desirable to have a method and apparatus that overcome the technical problem of presenting a potentially competitive resource allocation for an organization.

### SUMMARY

According to one embodiment of the present invention, a method provides for digitally presenting a comparison of labor resource allocations between organizations. Employee data is identified for a set of employees. The employee data including job titles, and job descriptions. Using a set of machine learning models, skills data is extracted from the job descriptions. Based on the skills data extracted from the job descriptions and using the set of machine learning models, the job titles are mapped to normalized titles within a job taxonomy that governs relationships between business functions, subfunctions, and the normalized titles. A resource allocation is determined for an organization over each of the normalized titles. A granular comparison is generated comparing the granular resource allocation to a set of benchmark allocations. The granular comparison is digitally presented in a graphical user interface.

According to another embodiment of the present invention, a computer system comprises a hardware processor, a display system, and a classification engine, in communication with the hardware processor, for digitally presenting a comparison of labor resource allocations between organizations. The classification engine is configured: to identify employee data for a set of employees, the employee data including job titles, and job descriptions; to extract, using a set of machine learning models, skills data from the job descriptions; based on the skills data extracted from the job descriptions, to map, using the set of machine learning models, the job titles to normalized titles within a job taxonomy that governs relationships between business functions, subfunctions, and the normalized titles; to determine a resource allocation for an organization over each of the normalized titles; to generate a granular comparison of the granular resource allocation to a set of benchmark allocations; and to digitally present the granular comparison in a graphical user interface.

According to yet another embodiment of the present invention, a computer program product comprises a computer-readable storage media with program code stored on the computer-readable storage media for digitally presenting a comparison of labor resource allocations between organizations. The program code comprising: code for identifying employee data for a set of employees, the employee data including job titles, and job descriptions; code for extracting, using a set of machine learning models, skills data from the job descriptions; code for mapping, based on the skills data extracted from the job descriptions and using the set of machine learning models, the job titles to normalized titles within a job taxonomy that governs relationships between business functions, subfunctions, and the normalized titles; code for determining a resource allocation for an organization over each of the normalized titles; code for generating a granular comparison of the granular resource allocation to a set of benchmark allocations; and code for digitally presenting the granular comparison in a graphical user interface.

### BRIEF DESCRIPTION OF THE DRAWINGS

FIG. 1 is a pictorial representation of a network of data processing systems in which illustrative embodiments may be implemented;

FIG. 2 is a block diagram of a job classification environment in accordance with an illustrative embodiment;

FIG. 3 is a block diagram illustrating a job taxonomy in which illustrative embodiments can be implemented;

FIG. 4 is a graphical user interface displaying a resource allocation at a business function level depicted in accordance with an illustrative embodiment;

FIG. 5 is a graphical user interface displaying a resource allocation at a normalized title level depicted in accordance with an illustrative embodiment;

FIG. 6 is a graphical user interface for adding selected benchmark allocations depicted in accordance with an illustrative embodiment;

FIG. 7 is a graphical user interface displaying a comparison of resource allocation for a selected organization to benchmark allocations at a business function level depicted in accordance with an illustrative embodiment;

FIG. 8 is a graphical user interface displaying a resource allocation at a normalized title level depicted in accordance with an illustrative embodiment;

FIG. 9 is a flowchart of a process for digitally presenting a comparison of labor resource allocations between organizations depicted in accordance with an illustrative embodiment;

FIG. 10 is a flowchart of a process for generating a granular comparison of labor resource allocations depicted in accordance with an illustrative embodiment;

FIG. 11 is a flowchart of a process for identifying a set of organizations depicted in accordance with an illustrative embodiment;

FIG. 12 is a flowchart of a process for mapping job titles to normalized titles within a job taxonomy depicted in accordance with an illustrative embodiment;

FIG. 13 is a flowchart of a process for performing an operation for an organization depicted in accordance with an illustrative embodiment;

FIG. 14 is a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about capital allocation when performing certain operations. Furthermore, identifying appropriate investments into business units for companies of a particular size and industry may also be desirable. The illustrative embodiments also recognize and take into account that searching information systems for successful allocations may be more cumbersome and time-consuming than desirable. For example, because specific responsibilities and descriptions of job positions may vary among different organizations, optimal investment strategies across a business sector often cannot be determined.

The illustrative embodiments also recognize and take into account that digitally presenting a potentially competitive resource allocation for an organization may facilitate accessing information about appropriate investments into business units for companies of a particular size and industry when performing operations for an organization. The illustrative embodiments also recognize and take into account that identifying a potentially competitive resource allocation may still be more difficult than desired. The illustrative embodiments also recognize and take into account that machine learning is a technology that can now be incorporated in finding patterns and trends in corporate resource allocation. The illustrative embodiments further recognize and take into account that machine learning allows for the construction of corporate resource allocation models and subsequently presenting these models digitally.

Thus, the illustrative embodiments provide a method and apparatus for digitally presenting a comparison of labor resource allocations between organizations. In one illustrative example, a computer system identifies employee data for a set of employees. The employee data includes job titles, and job descriptions. Using a set of machine learning models, the computer system extracts skills data from the job descriptions. Based on the skills data extracted from the job descriptions and using the set of machine learning models, the computer system maps the job titles to normalized titles within a job taxonomy that governs relationships between business functions, subfunctions, and the normalized titles. The computer system determines a resource allocation for an organization over each of the normalized titles. The computer system generates a granular comparison of the granular resource allocation to a set of benchmark allocations. The computer system digitally presents the granular comparison in a graphical user interface.

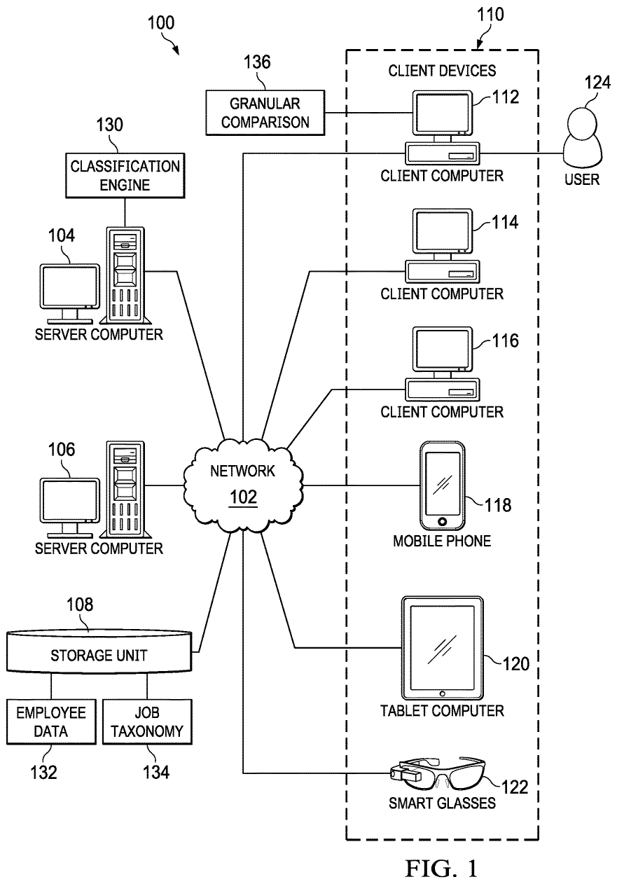

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user 124 operates client computer 112. In the illustrative example, classification engine 130 can process employee data 132, including job titles and for employees of an organization. Using skills data extracted from job descriptions in the employee data 132, classification engine 130 creates a mapping between a job title identified in employee data 132 and normalized titles within job taxonomy 134.

Job taxonomy 134 is a hierarchical classification scheme for organizing an organization's workforce. Job taxonomy 134 essentially serves as a proxy for business departments, aligning the thousands of job titles used by different organizations to business functions and subfunctions that best represent the workforce.

In this illustrative example, classification engine 130 can run on server computer 104. In another illustrative example, classification engine 130 can run on client computer 114 and can take the form of a system instance of the application. In yet other illustrative examples, classification engine 130 can be distributed in multiple locations within network data processing system 100. For example, classification engine 130 can run on client computer 112 and on client computer 114 or on client computer 112 and server computer 104 depending on the particular implementation.

classification engine 130 can operate to provides a view of an organizational structure, including the ability to generate granular comparison 136 of an organization to similar benchmark organizations in their industry. User 124 can get a view of how an organization's human capital management metrics like headcount, payroll spend etc. distributed across business functions and job titles look like and measure across their industry.

The standardization provided by job taxonomy 134 allows user 124 to benchmark their organizational setup. For example, user 124 can benchmark the headcount and payroll spend distribution of one organization to the standardized business functions, subfunctions, and job-titles provided by job taxonomy 134. The standardization provided by job taxonomy 134 allows classification engine 130 to present a granular comparison 136 down to an individual employee level. This granular comparison 136 of the employee data 132 at an individual employee level is not provided by prior systems.

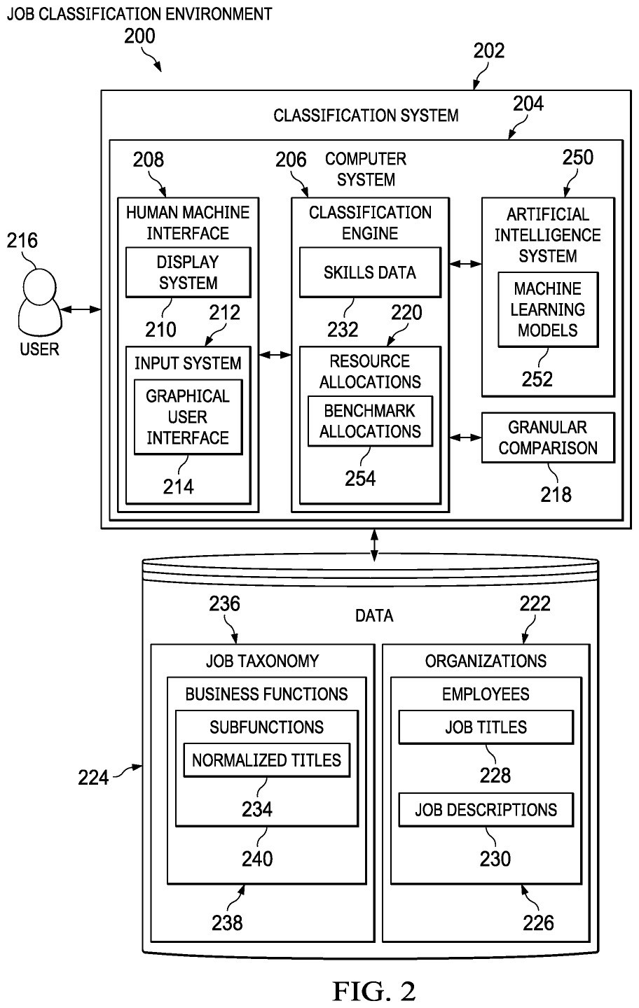

With reference now to FIG. 2, a block diagram of a job classification environment is depicted in accordance with an illustrative embodiment. In this illustrative example, job classification environment 200 includes components that can be implemented in hardware such as the hardware shown in network data processing system 100 in FIG. 1.

In this illustrative example, classification system 202 in computer system 204 is configured to provide a granular view of an organizational structure, including the ability to generate granular comparison 218 of an organization to similar benchmark organizations in their industry. User 216 can get a view of how an organization's human capital management metrics like headcount, payroll spend etc. distributed across business functions and job titles look like and measure across their industry.

As depicted, classification system 202 comprises computer system 204 and classification engine 206. classification engine 206 runs in computer system 204. classification engine 206 can be implemented in software, hardware, firmware, or a combination thereof. When software is used, the operations performed by classification engine 206 can be implemented in program code configured to run on hardware, such as a processor unit. When firmware is used, the operations performed by classification engine 206 can be implemented in program code and data and stored in persistent memory to run on a processor unit. When hardware is employed, the hardware may include circuits that operate to perform the operations in classification engine 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, human machine interface 208 comprises display system 210 and input system 212. Display system 210 is a physical hardware system and includes one or more display devices on which graphical user interface 214 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 216 is a person that can interact with graphical user interface 214 through user input generated by input system 212 for computer system 204. Input system 212 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 208 can enable user 216 to interact with one or more computers or other types of computing devices in computer system 204. For example, these computing devices can be client devices such as client devices 110 in FIG. 1.

In this illustrative example, classification engine 206 is configured to digitally present a granular comparison 218 of labor resource allocations 220 between organizations 222. In one illustrative example, classification engine 206 identifies data 224 for a set of employees 226.

Organizations 222 may be, for example, a corporation, a partnership, a charitable organization, a city, a government agency, or some other suitable type of organization. Employees 226 are people who are employed by or associated with one of organizations 222. For example, employees 226 can include at least one of employees, administrators, managers, supervisors, and third parties associated with organization 222. Data 224 about employees 226 can include job titles 228 and job descriptions 230.

Labor resource allocations 220 are the distributions of resources among different business functions 238 for different ones of organizations 222. Organizations 222 allocate resources among business functions 238 in furtherance of goals of organizations 222 or in support of the operations of organizations 222.

In this illustrative example, classification engine 206 extracts skills data 232 from the job descriptions 230. Job descriptions 230 list information such as skill sets and competencies, experience, training programs, certifications, and educational background required associated with job titles 228. Resume data might comprise, among other things, previous positions held, certifications, and skill sets and competencies. Job description 230 may also include additional classification information, such as Employee Information Report (EEO-1), a Standard Occupational Classification (SOC), and a North American Industry Classification System (NAICS) class, as well as other possible information indicative of job responsibilities within organizations 222.

Based on the skills data 232 extracted from the job descriptions 230, classification engine 206 maps the job titles 228 to normalized titles 234 within a job taxonomy 236. Job taxonomy 236 is an example of job taxonomy 134 of FIG. 1. Job taxonomy 236 governs relationships between business functions 238, subfunctions 240, and the normalized titles 234.

Normalized titles 234 are standardized job titles based on skills data 232 of the employees that occupy the associated employment position. Different ones of organizations 222 may use different job titles 228 to described employees having similar responsibilities. Therefore, normalized titles 234 provides a standardized nomenclature to directly compare employees 226 across different ones of organizations 222.

In some illustrative examples, classification engine 206 can use artificial intelligence system 250 having a set of machine learning models 252 to map the job titles 228 to normalized titles 234 within a job taxonomy 236. Artificial intelligence system 250 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 250 can include a set of machine learning models 252. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

The set of machine learning models 252 is trained from job titles 228, job descriptions 230, and job taxonomy 236. When trained using an appropriate training data set, one or more of machine learning models 252 can be used to identify skills data 232, and to generate mappings between job titles 228 and normalized titles 234 based on job descriptions 230.

Artificial intelligence system 250 can validate training of machine learning models 252 using validation data, which can include and use a subset of data 224 about employees 226. Artificial intelligence system 250 analyzes the process and results of validation data to determine whether artificial intelligence system 250 performs with a desired level of accuracy. When a desired level of accuracy is reached, classification system 202 identify skills data 232, and generate mappings between job titles 228 and normalized titles 234 based on job descriptions 230.

In this illustrative example, classification engine 206 determines a resource allocation 220 for one of organizations 222 over each of the normalized titles 234. Classification engine 206 generates a granular comparison 218 of the resource allocation 220 to a set of benchmark allocations 254. Classification engine 206 digitally presenting the granular comparison 218 in a graphical user interface 214.

In one illustrative example, user 216 can use graphical user interface 214 to select benchmark allocations 254 based on organizational characteristics such as, but not limited to industry, employee size and revenue size. Classification engine 206 then creates benchmark allocations 254 from data 224 for organizations 222 matching the selected characteristics.

Because classification system 202 identifies allocations based on the standardization provided in job taxonomy 236, classification system 202 provides a granular view of organizational structure with the ability to compare organizations to lookalike organizations in their industry. Furthermore, Organizations can get a view of how their human capital management metrics like headcount, payroll spend etc. distributed across business functions and job titles look like and measure across their industry.

Using the standardization provided by job taxonomy 236, including standardized business functions 238, subfunctions 240, and normalized titles 234, organizations can benchmark their labor resource allocations 220, such as headcount and payroll spend distribution, at a more granular level that provided by prior systems.

For the first time, classification system 202 allows organizations 222 to benchmark their headcount, labor costs and turnover against others in the industry to determine granular comparison 218. Granular comparison 218 allows organizations 222 to identify areas of their business that are too lean or too heavy, based on benchmark allocations 254. Classification system 202 provides the opportunity for organizations 222 to understand their own labor resource allocations 220, and if they need to adjust their strategy based on evolving trends in an industry.

The illustrative example in FIG. 2 and the examples in the other subsequent figures provide one or more technical solutions to overcome a technical problem of determining a resource allocation for an organization that make the performance of operations for an organization more cumbersome and time-consuming than desired. For example, organizations 222 can perform operations consistent with labor resource allocations 220 based on a granular comparison 218 to benchmark allocations 254.

In this manner, the use of classification system 202 has a technical effect of determining normalized titles 234 for employees 226 of organizations 222, and generating a granular comparison 218 based on a set of benchmark allocations 254 across a standardized job taxonomy 236, thereby reducing time, effort, or both in the performance of operations of different organizations 222. In this manner, operations performed for organizations 222 may be performed more efficiently as compared to currently used systems that do not include classification engine 206. For example, operations, such as, but not limited to, at least one of hiring, benefits administration, payroll, performance reviews, forming teams for new products, assigning research projects, or other suitable operations for organizations 222, performed consistent labor resource allocations 220 based on standardized job taxonomy 236 allows an organization to allocate resources across business functions 238 based on granular characteristics identified for other organizations.

Thus, classification engine 206 transforms computer system 204 into a special purpose computer system as compared to currently available general computer systems that do not have classification engine 206. Currently used general computer systems do not reduce the time or effort needed to generate a granular comparison 218 of labor resource allocations 220 based on a standardized job taxonomy 236 and benchmark allocations 254.

The illustration of job classification environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

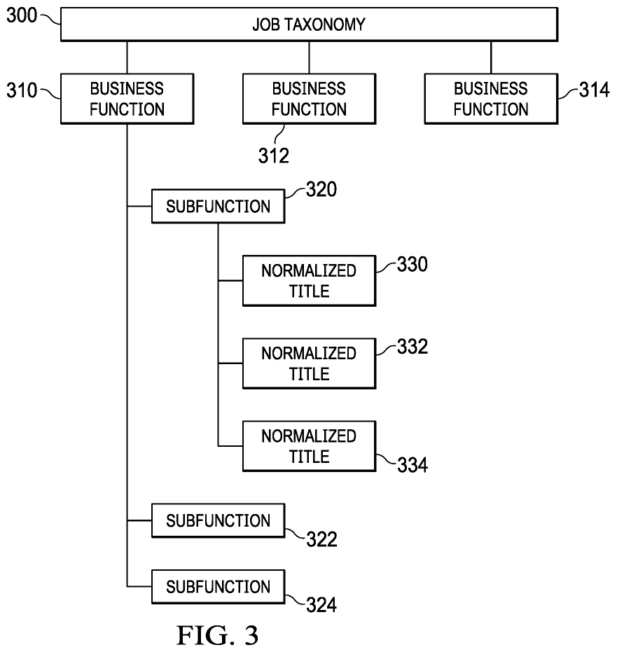

Referring now to FIG. 3, a block diagram is shown that illustrates a job taxonomy in which illustrative embodiments can be implemented. Job taxonomy 300 is an example of job taxonomy 236, shown in block form in FIG. 2.

As depicted, job taxonomy 300 is a hierarchical classification scheme for organizing an organization's workforce. Job taxonomy 134 essentially serves as a proxy for business departments, aligning the thousands of job titles used by different organizations to business functions and subfunctions that best represent the workforce.

Job taxonomy 300 includes one or more business functions, such as business function 310, business function 312, and business function 314. Each business function is divided into subfunctions, such as sub function 320, subfunction 322, and subfunctions 324. Normalized job titles, such as normalized titles 330, normalized title 332, and the normalized title 334 are mapped to a subfunction based on skills data determined from an associated job description.

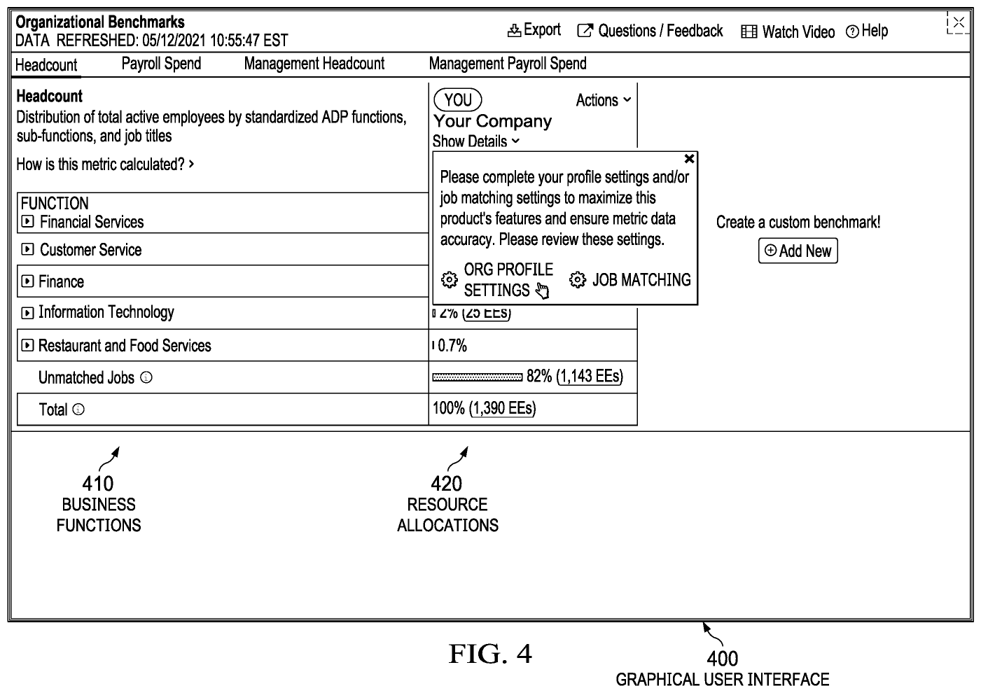

Turning now to FIGS. 4-8, illustrations of a graphical user interface for displaying a granular comparison of labor resource allocations is depicted in accordance with an illustrative embodiment. Referring specifically to FIG. 4, a graphical user interface displaying a resource allocation at a business function level is depicted in accordance with an illustrative embodiment. As depicted, graphical user interface 400 is an example one this implementation for graphical user interface 214 in FIG. 2.

As depicted, graphical user interface 400 displays a list of relevant business functions 410. Business functions 410 include one or more business functions from a job taxonomy, such as job taxonomy 236, to which the selected organization has allocated resources.

In the next column, graphical user interface 400 displays labor resource allocations 420 for the selected organization. Graphical user interface can display labor resource allocations 420 based on different parameters, such as, for example, headcount or payroll spending for the selected organizations. Labor resource allocations 420 are distributed by business functions, subfunctions and job titles.

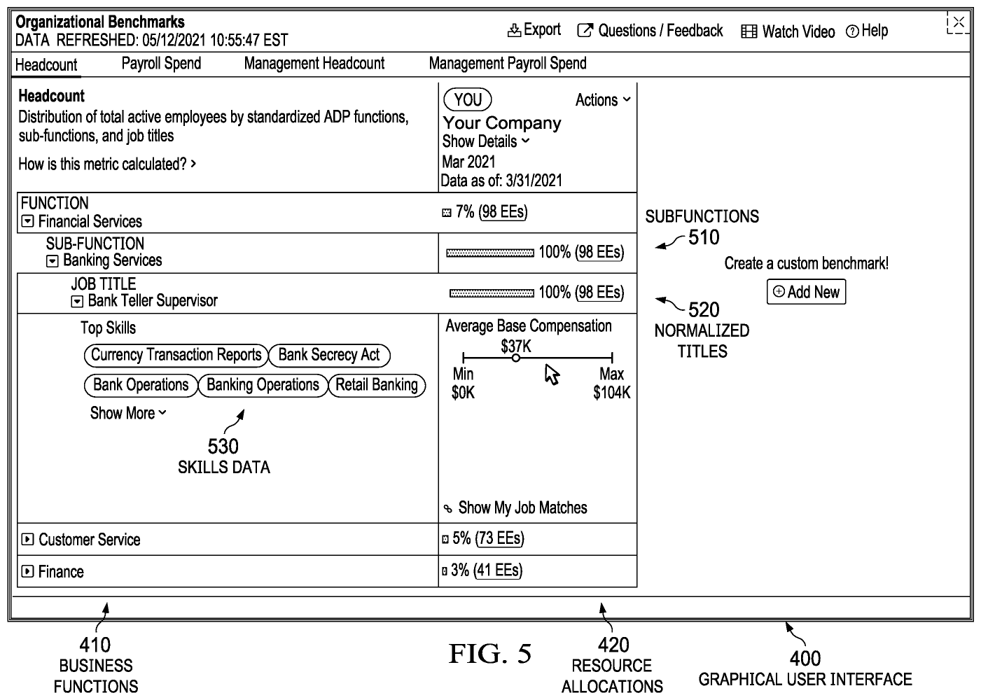

Referring now to FIG. 5, a graphical user interface displaying a resource allocation at a normalized title level is depicted in accordance with an illustrative embodiment. More specifically, FIG. 5 displays graphical user interface 400, wherein a particular business function is expanded to show a granular distribution of labor resource allocations among normalized titles categorized therein.

Labor resource allocations 420 are distributed by business functions, subfunctions and job titles. By interacting with the various controls within graphical user interface 400, a user can drill into a business function to see the respective subfunctions 510 and normalized titles 520, enabling a more granular view of labor resource allocations 420 of the selected organization.

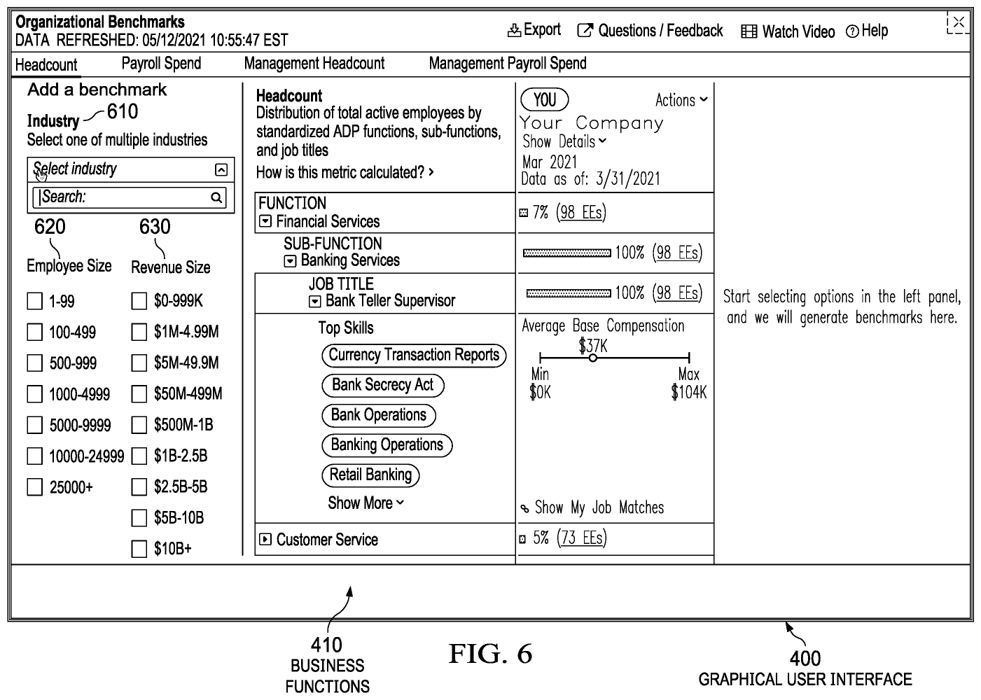

Referring now to FIG. 6, a graphical user interface for adding selected benchmark allocations is depicted in accordance with an illustrative embodiment. More specifically, FIG. 6 displays graphical user interface 400, wherein a benchmark allocation can be defined for comparison to the selected organization.

By interacting with the various controls within graphical user interface 400, graphical user interface 400 enables a user to define and select benchmark allocations based on organizational characteristics such as, but not limited to industry, employee size and revenue size. A classification engine, such as classification engine 206 of FIG. 2, then creates benchmark allocations from data for organizations that match the selected characteristics.

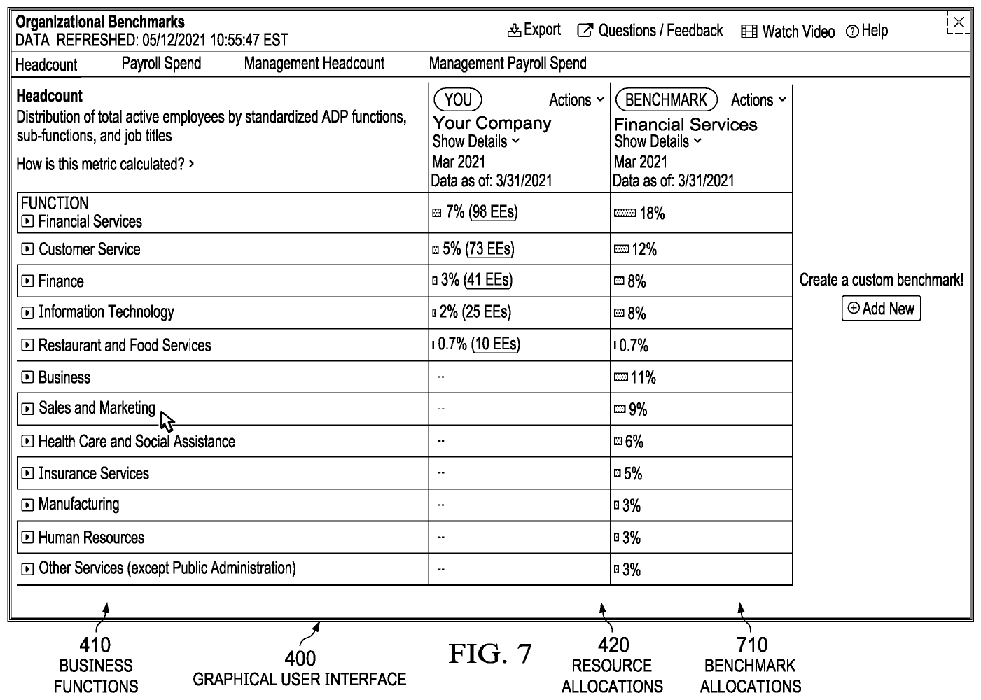

Referring specifically to FIG. 7, a graphical user interface displaying a comparison of resource allocation for a selected organization to benchmark allocations at a business function level is depicted in accordance with an illustrative embodiment. More specifically, FIG. 6 displays graphical user interface 400, wherein of labor resource allocations 420 are compared to benchmark allocations that were defined in the graphical user interface of FIG. 6.

Graphical user interface 400 displays benchmark allocations 710. Benchmark allocations 710 are generated based on selected organizational characteristics such as, but not limited to industry, employee size and revenue size, as illustrated in FIG. 6. Graphical user interface 400 can display benchmark allocations 710 based on different parameters, such as, for example, headcount or payroll spending for the selected organizations. Benchmark allocations 710 are distributed by business functions, subfunctions and job titles.

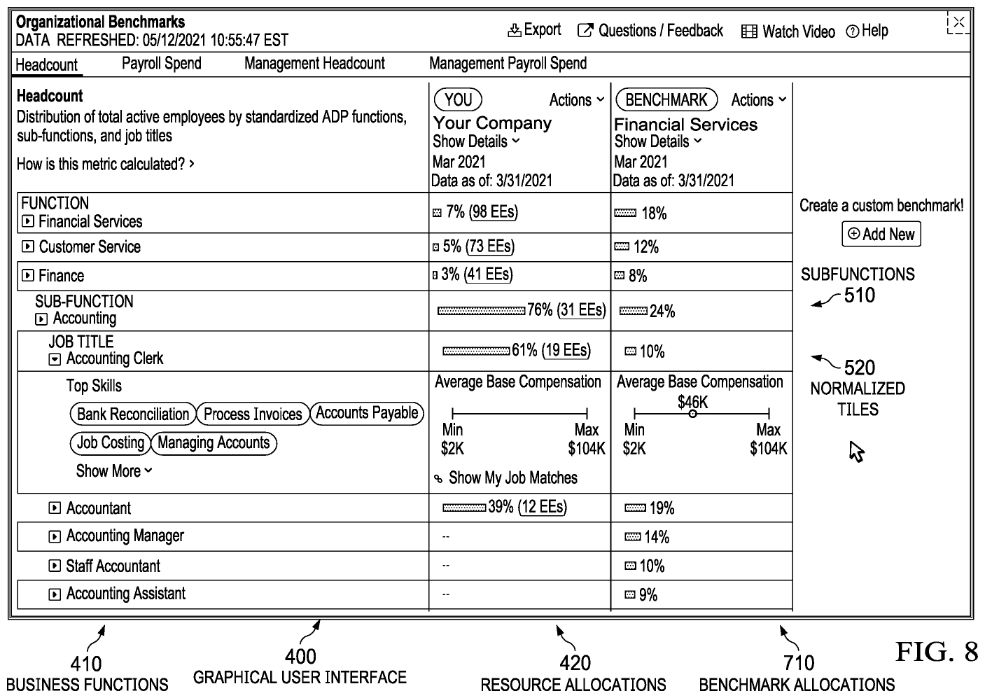

Referring now to FIG. 8, a graphical user interface displaying a resource allocation at a normalized title level is depicted in accordance with an illustrative embodiment. More specifically, FIG. 8 displays graphical user interface 400, wherein a particular business function is expanded to show a granular distribution of labor resource allocations among normalized titles categorized therein.

Labor resource allocations 420 are distributed by business functions, subfunctions and job titles. By interacting with the various controls within graphical user interface 400, a user can drill into a business function to see the respective subfunctions 510 and normalized titles 520, enabling a granular comparison of labor resource allocations 420 of the selected organization to benchmark allocations 710.

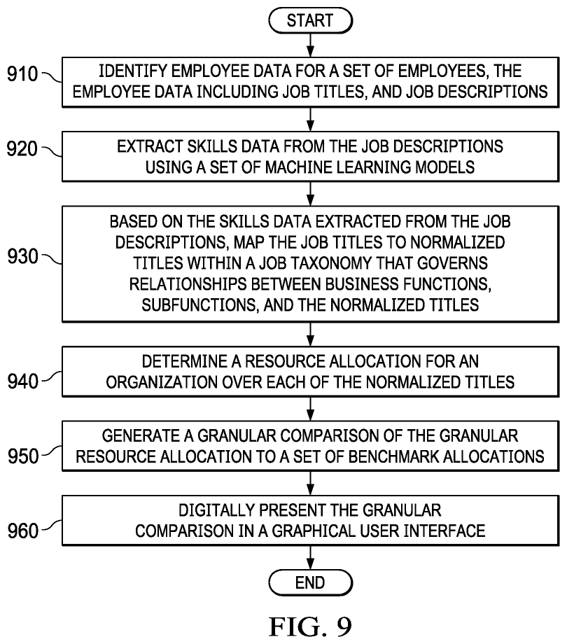

Turning next to FIG. 9, a flowchart of a process for digitally presenting a comparison of labor resource allocations between organizations is depicted in accordance with an illustrative embodiment. The process in FIG. 9 can be implemented in hardware, software, or both. When implemented in software, the process can take the form of program code that is run by one or more processor units located in one or more hardware devices in one or more computer systems. For example, the process can be implemented in classification engine 206 in computer system 204 in FIG. 2.

The process identifies employee data for a set of employees, the employee data including job titles, and job descriptions (step 910). The employee data can be, for example, data 224 about employees 226, both shown in block form in FIG. 2.

In one illustrative example, the employee data can include additional information. For example, employee data may additionally comprise human resources information that includes an employee information report of the employee, a standard occupational classification of the employee, a job title of the employee, an EEO-1 job category, a North American Industry Classification System class of the employee, a salary grade of the employee, an age of the employee, and a tenure of the employee at the organization. The employee data may additionally comprise payroll information that includes an annual base salary of the employee, a bonus ratio of the employee, and overtime pay of the employee. The employee data may additionally comprise specific job indicators that include a specific job level indication, a reporting hierarchy of the organization, a description of employee responsibilities, and an employee information report, the standard occupational classification of the employee, the annual base salary of the employee, and a bonus ratio of the employee.

The process uses a set of machine learning models to extract skills data from the job descriptions (step 920). Based on the skills data extracted from the job descriptions and using the set of machine learning models, the process maps the job titles to normalized titles within a job taxonomy that governs relationships between business functions, subfunctions, and the normalized titles (step 930). The job taxonomy can be job taxonomy 236 of FIG. 2.

In one illustrative example, the taxonomy comprises a number of business functions. For example, the taxonomy can comprise business functions including a finance function, a sales and marketing function, a customer service function, a human resources function, an information technology function, a legal function, a real-estate function, a marketing and sales function, an operations function, a product development function, and a supports function, as well as other suitable functions.

The process determines a resource allocation for an organization over each of the normalized titles (step 940). The process generates a granular comparison of the granular resource allocation to a set of benchmark allocations (step 950), and digitally presents the granular comparison in a graphical user interface (step 960). The process terminates thereafter.

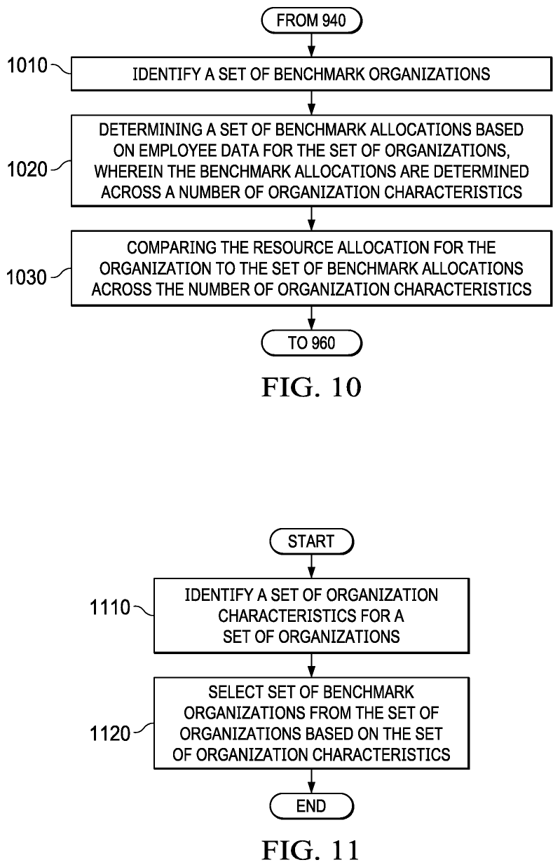

With reference next to FIG. 10, a flowchart of a process for generating a granular comparison of labor resource allocations is depicted in accordance with an illustrative embodiment. The process in FIG. 10 is an example one implementation for step 950 in FIG. 9.

Continuing from step 940 of FIG. 9, the process identifies a set of organizations (step 1010). The set of organizations can be identified based on selected organizational characteristics such as, but not limited to industry, employee size and revenue size.

The process determines the set of benchmark allocations based on employee data for the set of organizations, wherein the benchmark allocations are determined across a number of organization characteristics (step 1020). The process compares the resource allocation for the organization to the set of benchmark allocations across the number of organization characteristics (step 1030). The process can then continue to step 960 of FIG. 9.

With reference next to FIG. 11, a flowchart of a process for identifying a set of organizations is depicted in accordance with an illustrative embodiment. The process in FIG. 11 is an example one implementation for step 1010 in FIG. 10.

The process identifying a set of organization characteristics for a set of organizations (step 1110). The organization characteristics can be identified by receiving user selection of organization characteristics from within a graphical user interface, such as graphical user interface 400 of FIG. 6. The process selects the set of benchmark organizations from the set of organizations based on the set of organization characteristics (step 1120).

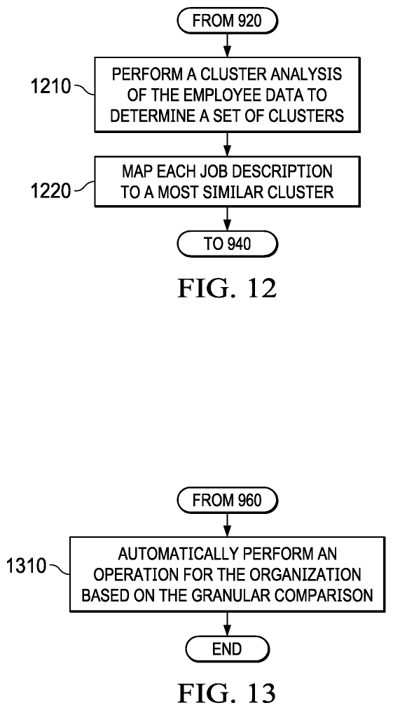

With reference next to FIG. 12, a flowchart of a process for mapping job titles to normalized titles within a job taxonomy is depicted in accordance with an illustrative embodiment. The process in FIG. 12 is an example one implementation for step 930 in FIG. 9.

Continuing from step 920, the process performs a cluster analysis of the employee data to determine a set of clusters (step 1210). The cluster analysis can be performed using one or more machine learning models trained with an appropriate data set, such as machine learning models 252 of FIG. 2. The process then maps each job description to a most similar cluster (step 1220). Thereafter, the process can continue to step 940 of FIG. 9.

With reference next to FIG. 13, a flowchart of a process for performing an operation for an organization is depicted in accordance with an illustrative embodiment. The process in FIG. 13 can be implemented in conjunction with process of FIG. 9.

Continuing from step 960 of FIG. 9, the process automatically performs an operation for the organization based on the granular comparison (step 1310). The operation is enabled based on the granular comparison of the resource allocation for the organization to the benchmark allocations. The operation can be selected from operations such as, but not limited to, hiring operations, benefits administration operations, payroll operations, performance review operations, forming teams for new products, and assigning research projects.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

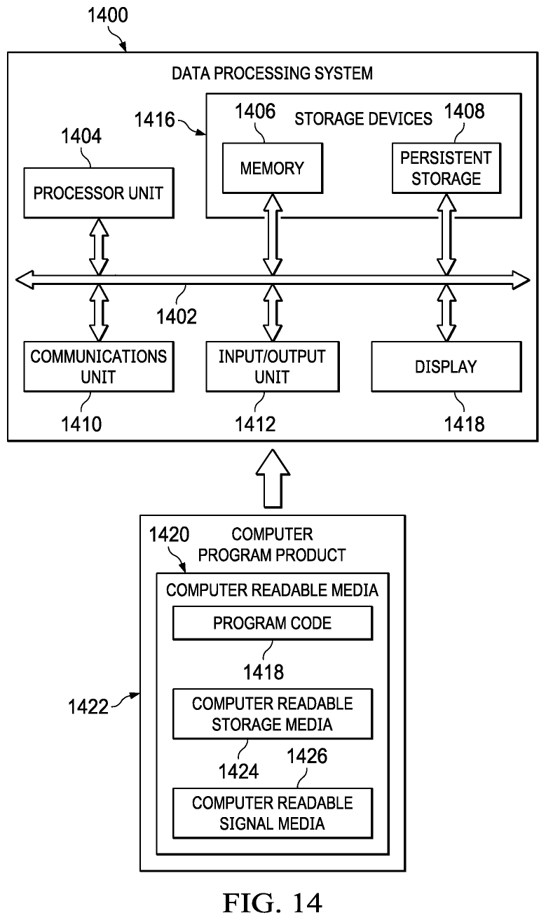

Turning now to FIG. 14, a block diagram of a data processing system is depicted in accordance with an illustrative embodiment. Data processing system 1400 can be used to implement server computer 104, server computer 106, client devices 110, in FIG. 1. Data processing system 1400 can also be used to implement computer system 204 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 takes the form of a bus system.

Processor unit 1404 serves to execute instructions for software that can be loaded into memory 1406. Processor unit 1404 includes one or more processors. For example, processor unit 1404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1404 can be implemented using one or more heterogeneous processor systems in which a main processor is present with secondary processors on a single chip. As another illustrative example, processor unit 1404 can be a symmetric multi-processor system containing multiple processors of the same type on a single chip.

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer-readable storage devices in these illustrative examples. Memory 1406, in these examples, can be, for example, a random-access memory or any other suitable volatile or non-volatile storage device. Persistent storage 1408 may take various forms, depending on the particular implementation.

For example, persistent storage 1408 may contain one or more components or devices. For example, persistent storage 1408 can be a hard drive, a solid-state drive (SSD), a flash memory, a rewritable optical disk, a rewritable magnetic tape, or some combination of the above. The media used by persistent storage 1408 also can be removable. For example, a removable hard drive can be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that can be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs can be located in storage devices 1416, which are in communication with processor unit 1404 through communications framework 1402. The processes of the different embodiments can be performed by processor unit 1404 using computer-implemented instructions, which may be located in a memory, such as memory 1406.

These instructions are program instructions and are also referred are referred to as program code, computer usable program code, or computer-readable program code that can be read and executed by a processor in processor unit 1404. The program code in the different embodiments can be embodied on different physical or computer-readable storage media, such as memory 1406 or persistent storage 1408.

Program code 1418 is located in a functional form on computer-readable media 1420 that is selectively removable and can be loaded onto or transferred to data processing system 1400 for execution by processor unit 1404. Program code 1418 and computer-readable media 1420 form computer program product 1422 in these illustrative examples. In the illustrative example, computer-readable media 1420 is computer-readable storage media 1424.

In these illustrative examples, computer-readable storage media 1424 is a physical or tangible storage device used to store program code 1418 rather than a medium that propagates or transmits program code 1418. Computer-readable storage media 1424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, is a limitation of the medium itself (i.e., tangible, not a signal) as opposed to a limitation on data storage persistency (e.g., RAM vs. ROM).

Alternatively, program code 1418 can be transferred to data processing system 1400 using a computer-readable signal media. The computer-readable signal media are signals and can be, for example, a propagated data signal containing program code 1418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” can be singular or plural. For example, program code 1418 can be located in computer-readable media 1420 in the form of a single storage device or system. In another example, program code 1418 can be located in computer-readable media 1420 that is distributed in multiple data processing systems. In other words, some instructions in program code 1418 can be located in one data processing system while other instructions in program code 1418 can be located in one data processing system. For example, a portion of program code 1418 can be located in computer-readable media 1420 in a server computer while another portion of program code 1418 can be located in computer-readable media 1420 located in a set of client computers.

The different components illustrated for data processing system 1400 are not meant to provide architectural limitations to the manner in which different embodiments can be implemented. In some illustrative examples, one or more of the components may be incorporated in or otherwise form a portion of, another component. For example, memory 1406, or portions thereof, may be incorporated in processor unit 1404 in some illustrative examples. The different illustrative embodiments can be implemented in a data processing system including components in addition to or in place of those illustrated for data processing system 1400. Other components shown in FIG. 14 can be varied from the illustrative examples shown. The different embodiments can be implemented using any hardware device or system capable of running program code 1418.

Thus, the illustrative embodiments provide a method and apparatus for digitally presenting a comparison of labor resource allocations between organizations. In one illustrative example, a computer system identifies employee data for a set of employees. The employee data includes job titles, and job descriptions. Using a set of machine learning models, the computer system extracts skills data from the job descriptions. Based on the skills data extracted from the job descriptions and using the set of machine learning models, the computer system maps the job titles to normalized titles within a job taxonomy that governs relationships between business functions, subfunctions, and the normalized titles. The computer system determines a resource allocation for an organization over each of the normalized titles. The computer system generates a granular comparison of the granular resource allocation to a set of benchmark allocations. The computer system digitally presents the granular comparison in a graphical user interface.

Because the classification system of the present invention identifies allocations based on the standardization provided in a job taxonomy, the embodiments described herein provide a granular view of organizational structure with the ability to compare organizations to lookalike organizations in their industry. Furthermore, Organizations can get a view of how their human capital management metrics like headcount, payroll spend etc. distributed across business functions and job titles look like and measure across their industry. Using the standardization provided by a job taxonomy, including standardized business functions, subfunctions, and normalized titles, organizations can benchmark their labor resource allocations, such as headcount and payroll spend distribution, at a more granular level that provided by prior systems.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for digitally presenting a comparison of labor resource allocations between organizations, the method comprising:
identifying, by a computer system, employee data for a set of employees, the employee data including job titles, and job descriptions;
extracting, by the computer system using a set of machine learning models, skills data from the job descriptions;
based on the skills data extracted from the job descriptions mapping, by the computer system using the set of machine learning models, the job titles to normalized titles within a job taxonomy that governs relationships between business functions, subfunctions, and the normalized titles;
determining, by the computer system, a resource allocation for an organization over each of the normalized titles;
generating, by the computer system, a granular comparison of the granular resource allocation to a set of benchmark allocations; and
digitally presenting the granular comparison in a graphical user interface.

2. The method of claim 1, wherein the taxonomy comprises a number of business functions including a finance function, a sales and marketing function, a customer service function, a human resources function, an information technology function, a legal function, a real-estate function, a marketing and sales function, an operations function, a product development function, and a supports function and more.

3. The method of claim 2, wherein each business function comprises a set of subfunctions related to a corresponding business function.

4. The method of claim 1, further comprising:
identifying a set of organizations;
determining the set of benchmark allocations based on employee data for the set of organizations, wherein the benchmark allocations are determined across a number of organization characteristics; and
comparing, by the computer system, the resource allocation for the organization to the set of benchmark allocations across the number of organization characteristics.

5. The method of claim 4, wherein determining the set of organizations further comprises:
identifying a set of organization characteristics for a set of organizations; and
selecting the set of benchmark organizations from the set of organizations based on the set of organization characteristics.

6. The method of claim 1, wherein mapping the job titles to normalized titles within a job taxonomy further comprises:
performing a cluster analysis of the employee data to determine a set of clusters, wherein each cluster corresponds to one of the normalized titles; and
mapping, by the computer system, each job description to a most similar cluster.

7. The method of claim 1, wherein the employee data further comprises human resources information that includes an employee information report of the employee, a standard occupational classification of the employee, a job title of the employee, an EEO-1 job category, a North American Industry Classification System class of the employee, a salary grade of the employee, an age of the employee, and a tenure of the employee at the organization.

8. The method of claim 1, wherein the employee data comprises payroll information that includes an annual base salary of the employee, a bonus ratio of the employee, and overtime pay of the employee.

9. The method of claim 1, wherein the employee data comprises specific job indicators that include a specific job level indication, a reporting hierarchy of the organization, a description of employee responsibilities, and an employee information report, the standard occupational classification of the employee, the annual base salary of the employee, and a bonus ratio of the employee.

10. The method of claim 1, further comprising:
automatically performing, by the computer system, an operation for the organization based on the granular comparison, wherein the operation is enabled based on the granular comparison of the resource allocation for the organization to the benchmark allocations, wherein the operation is selected from hiring operations, benefits administration operations, payroll operations, performance review operations, forming teams for new products, and assigning research projects.

11. A computer system comprising:
a hardware processor;
a display system; and
a classification engine, in communication with the hardware processor, for digitally presenting a comparison of labor resource allocations between organizations, wherein the classification engine is configured:
to identify employee data for a set of employees, the employee data including job titles, and job descriptions;
to extract, using a set of machine learning models, skills data from the job descriptions;
based on the skills data extracted from the job descriptions, to map, using the set of machine learning models, the job titles to normalized titles within a job taxonomy that governs relationships between business functions, subfunctions, and the normalized titles;
to determine a resource allocation for an organization over each of the normalized titles;
to generate a granular comparison of the granular resource allocation to a set of benchmark allocations; and
to digitally present the granular comparison in a graphical user interface.

12. The computer system of claim 11, wherein the taxonomy comprises a number of business functions including a finance function, a sales and marketing function, a customer service function, a human resources function, an information technology function, a legal function, a real-estate function, a marketing and sales function, an operations function, a product development function, and a supports function and more.

13. The computer system of claim 12, wherein each business function comprises a set of subfunctions related to a corresponding business function.

14. The computer system of claim 11, wherein the classification engine is further configured:
to identify a set of organizations;
to determine the set of benchmark allocations based on employee data for the set of organizations, wherein the benchmark allocations are determined across a number of organization characteristics; and
to compare the resource allocation for the organization to the set of benchmark allocations across the number of organization characteristics.

15. The computer system of claim 14, wherein in determining the set of organizations, the classification engine is further configured:
to identify a set of organization characteristics for a set of organizations; and
to select the set of benchmark organizations from the set of organizations based on the set of organization characteristics.

16. The computer system of claim 11, wherein in determining the corresponding business function for each employee further comprises:
to perform a cluster analysis of the employee data to determine a set of clusters, wherein each cluster corresponds to one of the normalized titles; and
mapping, by the computer system, each job description to a most similar cluster.

17. The computer system of claim 11, wherein the employee data further comprises human resources information that includes an employee information report of the employee, a standard occupational classification of the employee, a job title of the employee, an EEO-1 job category, a North American Industry Classification System class of the employee, a salary grade of the employee, an age of the employee, and a tenure of the employee at the organization.

18. The computer system of claim 11, wherein the employee data comprises payroll information that includes an annual base salary of the employee, a bonus ratio of the employee, and overtime pay of the employee.

19. The computer system of claim 11, wherein the employee data comprises specific job indicators that include a specific job level indication, a reporting hierarchy of the organization, a description of employee responsibilities, and an employee information report, the standard occupational classification of the employee, the annual base salary of the employee, and a bonus ratio of the employee.

20. The computer system of claim 11, wherein the classification engine is further configured:
to automatically perform an operation for the organization based on the granular comparison, wherein the operation is enabled based on the granular comparison of the resource allocation for the organization to the benchmark allocations, wherein the operation is selected from hiring operations, benefits administration operations, payroll operations, performance review operations, forming teams for new products, and assigning research projects.

21. A computer program product comprising:
a computer readable storage media; and
program code, stored on the computer readable storage media, for digitally presenting a comparison of labor resource allocations between organizations, the program code comprising:
code for identifying employee data for a set of employees, the employee data including job titles, and job descriptions;
code for extracting, using a set of machine learning models, skills data from the job descriptions;
code for mapping, based on the skills data extracted from the job descriptions and using the set of machine learning models, the job titles to normalized titles within a job taxonomy that governs relationships between business functions, subfunctions, and the normalized titles;
code for determining a resource allocation for an organization over each of the normalized titles;
code for generating a granular comparison of the granular resource allocation to a set of benchmark allocations; and
code for digitally presenting the granular comparison in a graphical user interface.

22. The computer program product of claim 21, wherein the taxonomy comprises a number of business functions including a finance function, a sales and marketing function, a customer service function, a human resources function, an information technology function, a legal function, a real-estate function, a marketing and sales function, an operations function, a product development function, and a supports function and more.

23. The computer program product of claim 22, wherein each business function comprises a set of subfunctions related to a corresponding business function.

24. The computer program product of claim 21, wherein the program code further comprises:
code for identifying a set of organizations;
code for determining the set of benchmark allocations based on employee data for the set of organizations, wherein the benchmark allocations are determined across a number of organization characteristics; and
code for comparing the resource allocation for the organization to the set of benchmark allocations across the number of organization characteristics.

25. The computer program product of claim 24, wherein the code for determining the set of organizations further comprises:
code for identifying a set of organization characteristics for a set of organizations; and
code for selecting the set of benchmark organizations from the set of organizations based on the set of organization characteristics.

26. The computer program product of claim 21, wherein the code for mapping the job titles to normalized titles within a job taxonomy further comprises:
code for performing a cluster analysis of the employee data to determine a set of clusters, wherein each cluster corresponds to one of the normalized titles; and
code for mapping each job description to a most similar cluster.

27. The computer program product of claim 21, wherein the employee data further comprises human resources information that includes an employee information report of the employee, a standard occupational classification of the employee, a job title of the employee, an EEO-1 job category, a North American Industry Classification System class of the employee, a salary grade of the employee, an age of the employee, and a tenure of the employee at the organization.

28. The computer program product of claim 21, wherein the employee data comprises payroll information that includes an annual base salary of the employee, a bonus ratio of the employee, and overtime pay of the employee.

29. The computer program product of claim 21, wherein the employee data comprises specific job indicators that include a specific job level indication, a reporting hierarchy of the organization, a description of employee responsibilities, and an employee information report, the standard occupational classification of the employee, the annual base salary of the employee, and a bonus ratio of the employee.

30. The computer program product of claim 21, wherein the program code further comprises:
code for automatically performing, by the computer system, an operation for the organization based on the granular comparison, wherein the operation is enabled based on the granular comparison of the resource allocation for the organization to the benchmark allocations, wherein the operation is selected from hiring operations, benefits administration operations, payroll operations, performance review operations, forming teams for new products, and assigning research projects.
